(19) United States
(12) Patent Application Publication
(10) Pub. No.: US 2003/0004857 A1
(43) Pub. Date: Jan. 2, 2003

(54) Coordinating manufacturing by local and remote manufacturers for a personalized design in an electronic commerce system

(75) Inventors: Michael Wayne Brown, Georgetown, TX (US); Rabindranath Dutta, Austin, TX (US); Michael A. Paolini, Austin, TX (US); Newton James Smith JR., Austin, TX (US)

Correspondence Address: Marilyn Smith Dawkins, International Business Machines Corporation, Intellectual Property Law Dept. ,Internal Zip 4054, 11400 Burnet Road, Austin, TX, 78758, US

(73) Assignee: International Business Machines Corporation, Armonk, NY (US)

(21) Appl. No.: 09/895,932

(22) Filed: Jun. 29, 2001

(51) Int. Cl. G06F 17/60

(52) U.S. Cl. 705/37

(57) ABSTRACT

A method, system and program for coordinating multiple local and remote manufacturers for a manufacturing order is provided. A manufacturing order from a user is divided into multiple manufacturable parts. Next, a local bid request for the manufacturing order is submitted to multiple local manufacturers. In response to receiving multiple local bids for the manufacturing order, a remote bid request is submitted to multiple remote manufacturers for bidding on a selection of the manufacturable parts as requested in the local bids. The user selects from the bid options provided by local and remote manufacturers.

### CROSS-REFERENCE TO RELATED APPLICATIONS

The present application is related to the following copending applications, which are incorporated herein by reference:

(1) U.S. patent application Ser. No. ______ (Attorney Docket No. AUS920010356US1); and

(2) U.S. patent application Ser. No. ______ (Attorney Docket No. AUS920010357US1).

### BACKGROUND OF THE INVENTION

1. Technical Field

The present invention relates in general to electronic commerce and, in particular, to facilitating personalized designs where utilizing both remote and local manufacturers may be advantageous. Still more particularly, the present invention relates to brokering a personalized design among remote and local manufacturers such that a customer obtains a locally assembled, cost effective product.

2. Description of the Related Art

In recent years, with the development of computer network technology, an electronic commerce (e-commerce) system has developed in which consumers and vendors are connected via a network. Electronic commerce can occur between a consumer and a vendor through, for example, an online information service, the Internet, a bulletin board system (BBS) or electronic data interchange (EDI).

There are many different methods in which e-commerce may be implemented as there are a vast variety of commodities and services in need of being traded. Many e-commerce systems operate on a post and match process; that is, the systems work by having a prospective consumer bid on an item and if the bid matches the vendors's specified selling price, the item is sold to that consumer. In another example, many e-commerce systems involve on-line auctions where vendors place products or services up for bid and consumers electronically place bids for purchasing the products or services; the item is sold to the consumer with the highest bid.

Other e-commerce systems allow users to view a graphical rendering of products as the user selects from multiple options that change the appearance of the product utilizing software tools such as Shockwave™. For example, a graphical rendering of a shirt may be provided where the color of the shirt in the graphical rendering changes according to a color selected by the user.

The present e-commerce systems are limited in that some products are more advantageous to receive from a local manufacturer, however the user is typically ordering a product from a remote manufacturer, where the remote manufacturer ships the product via mail service. Moreover, where a user can order a product that is available for local delivery, the user is not provided with multiple bids for the product including local and remote manufacturer bids for the product. For example, where a user is purchasing a piece of jewelry or a perishable good, assembly of the jewelry or perishable good by a local jeweler or bakery may be preferable to receiving the piece of jewelry or perishable good via shipment.

Therefore, in view of the foregoing, it would be advantageous to provide a method, system and program for facilitating the personalized design of products where utilization of both local and remote manufacturers is advantageous.

### SUMMARY OF THE INVENTION

In view of the foregoing, it is therefore an object of the present invention to provide an improved method, system and program for performing electronic commerce.

It is another object of the present invention to provide a method, system and program for facilitating personalized designs where utilizing both remote and local manufacturers may be advantageous.

It is yet another object of the present invention to provide a method, system and program for brokering a personalized design among remote and local manufacturers such that a customer obtains a locally assembled, cost effective product.

According to one aspect of the present invention, a manufacturing order from a user is divided into multiple manufacturable parts. Next, a local bid request for the manufacturing order is submitted to multiple local manufacturers. In response to receiving multiple local bids for the manufacturing order, a remote bid request is submitted to multiple remote manufacturers for bidding on a selection of the manufacturable parts as requested in the local bids. The user is then enabled to select from the bid options provided by local and remote manufacturers.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic commerce typically takes place in accordance with the method, system and program of the present invention;

FIG. 3 depicts a block diagram of a preferred client/server environment for facilitating a personalized design and then procuring local and remote manufacturers for the personalized design according to the method, system and program of the present invention;

FIG. 4 illustrates a block diagram of one embodiment of a broker server system in accordance with the method, system and program of the present invention;

FIGS. 5A-5B depicts a high level logic flowchart of the process and program for facilitating and brokering personalized designs according to the method, system and program of the present invention;

FIG. 6 depicts a high level logic flowchart of a process and program for personalizing a design and placing an order for that personalized design according to the method, system and program of the present invention;

FIG. 7 depicts a high level logic flowchart of a process and program for controlling a local manufacturer system in accordance with the present invention;

FIG. 8 illustrates a block diagram of a data storage structure for products in accordance with the method, system and program of the present invention;

FIG. 9 depicts a block diagram of a data storage structure for local manufacturer registration information in accordance with the method, system and program of the present invention;

FIG. 10 illustrates a block diagram of a data storage structure for remote manufacturer registration information in accordance with the method, system and program of the present invention;

FIG. 11 depicts a block diagram of a data storage structure for user registration information in accordance with the method, system and program of the present invention;

FIG. 12 illustrates a block diagram of a data storage structure for tracking personalized designs in accordance with the method, system and program of the present invention;

FIG. 13 depicts a block diagram of a data storage structure for storing attribute and variable selections for a personalized design in accordance with the method, system and program of the present invention;

FIG. 14 illustrates a block diagram of a data storage structure for storing local manufacturer bids in accordance with the method, system and program of the present invention; and

FIG. 15 depicts a block diagram of a data storage structure for storing remote manufacturer bids in accordance with the method, system and program of the present invention.

### DETAILED DESCRIPTION OF THE PREFERRED EMBODIMENT

A method, system and program for facilitating user entry of personalized designs and procuring local and remote manufacturers for manufacturing portions of a personalized design order are provided, such that a local manufacturer can manufacture and assemble the personalized design order utilizing portions manufactured by the remote manufacturers. In the present invention, “user” preferably refers to the individual, group, organization, business or corporation submitting an order for a personalized design. “Personalized designs” preferably include both personalized products and services. “Personalized design order” preferably refers to requests for manufacture of both personalized products and services. “Remote manufacturer” preferably refers to the individual, group, organization, business, or corporation that will bid on a manufacturable portion of a personalized design order and then manufacture the manufacturable portion if selected, however the remote manufacturer may or may not actually be geographically remote to the buyer. “Local manufacturer” preferably refers to the individual, group, organization, business, or corporation that will assemble and manufacture portions of the personalized design order, however the local manufacturer may or may not actually be geographically local to the buyer.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Hardware Overview

The present invention may be executed in a variety of systems, including a variety of computing systems and electronic devices under a number of different operating systems. In one embodiment of the present invention, the computer system is a portable computing system such as a notebook computer, a palmtop computer, a personal digital assistant, a telephone or other electronic computing system that may also incorporate communications features that provide for telephony, enhanced telephony, messaging and information services. However, the computer system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

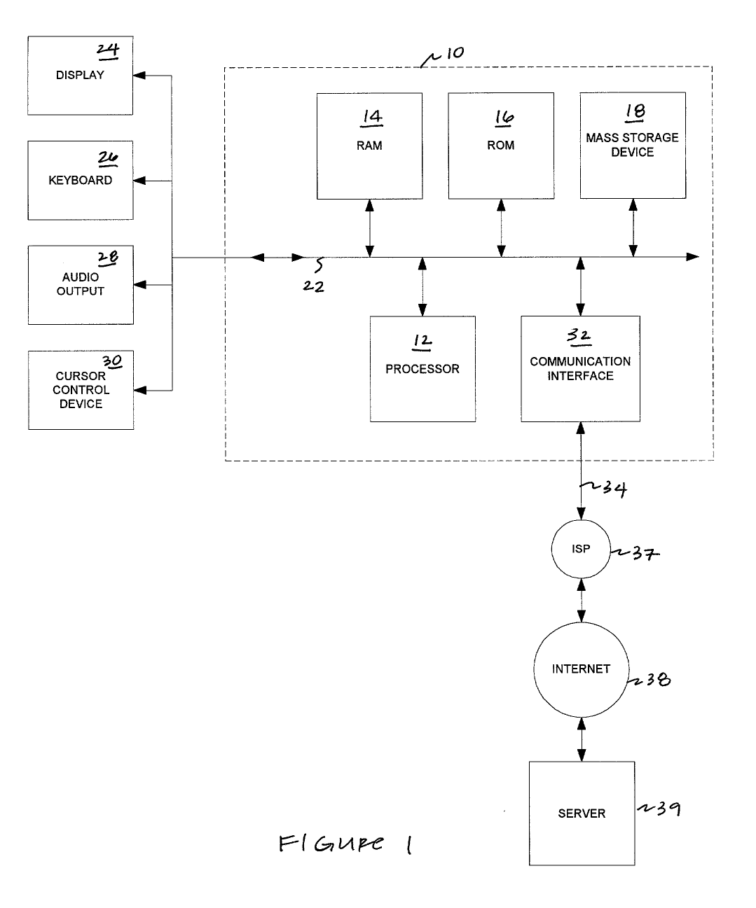

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

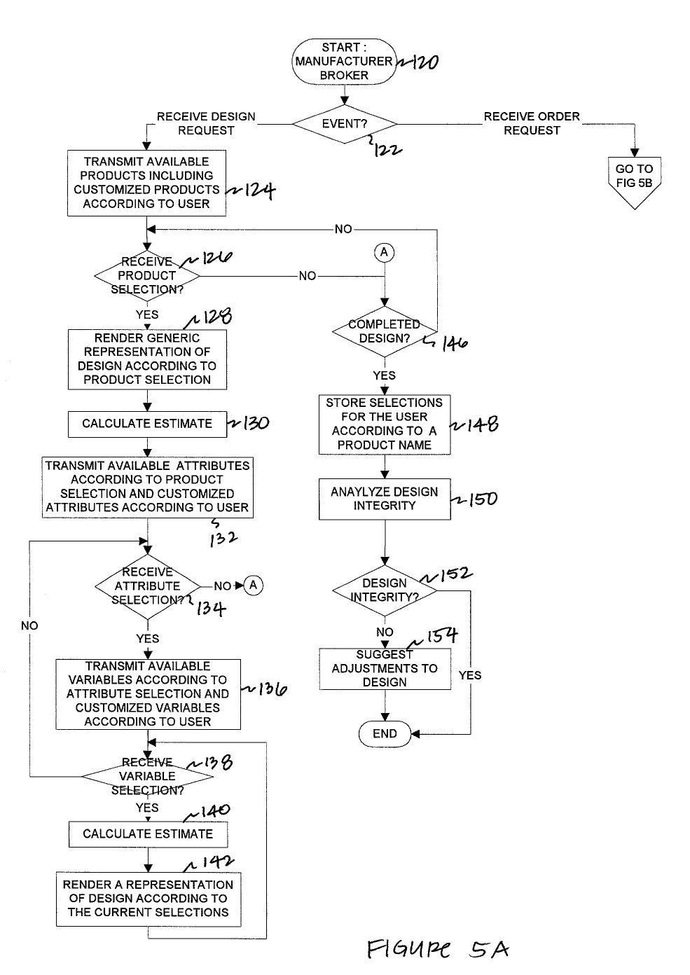

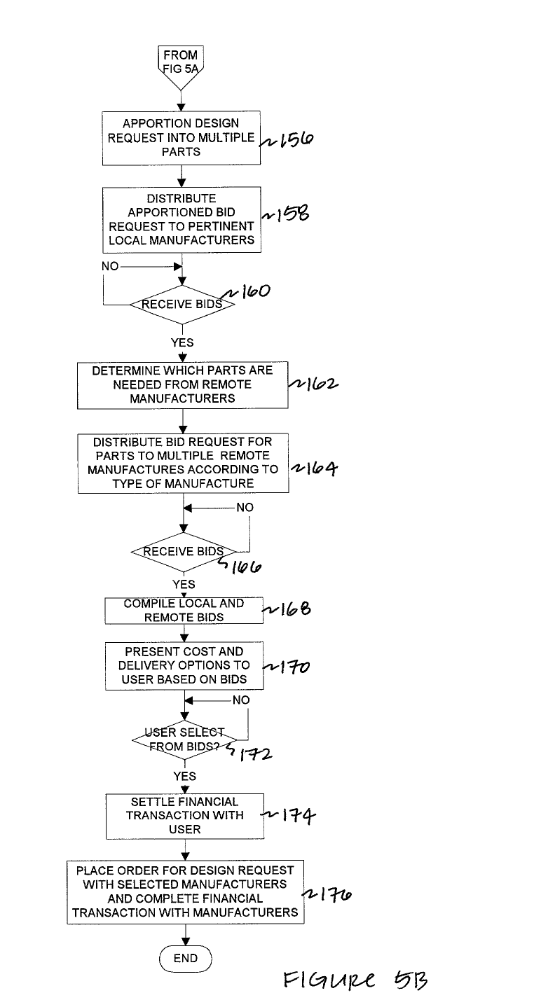

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 5, 6, 7, 8, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 (e.g., a client) by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

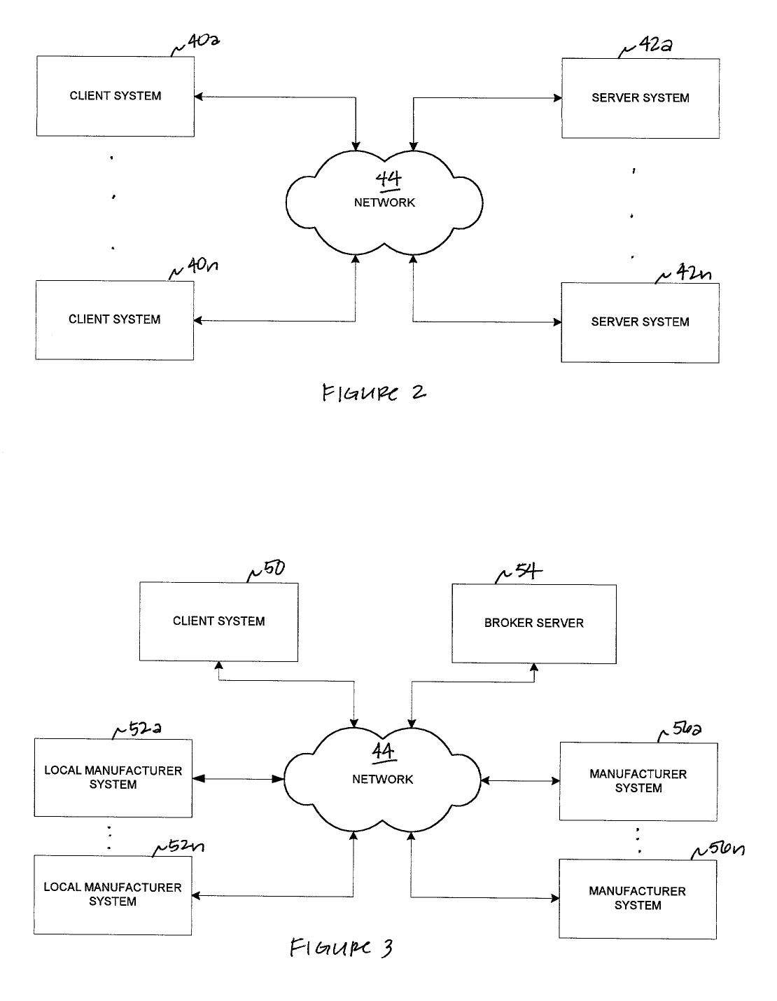

With reference now to FIG. 2, there is depicted a simplified block diagram of a client/server environment in which electronic commerce typically takes place in accordance with the method, system and program of the present invention. The client/server environment may be implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web Ace browsers such as Netscape Navigator™ typically reside on clients 40a-40n and render Web documents (pages) served by servers 42a-42n. Additionally, each of clients 40a-40n and servers 42a-42n may function as both a “client” and a “server” and may be implemented utilizing a computer system such as computer system 10 of FIG. 1.

The Web may refer to the total set of interlinked hypertext documents residing on servers all around the world. A network 44, such as the Internet, provides an infrastructure for transmitting these hypertext documents between clients 40a-40n and servers 42a-42n. Documents (pages) on the Web may be written in multiple languages, such as Hypertext Markup Language (HTML) or Extensible Markup Language (XML), and identified by Uniform Resource Indicators (URIs) that specify the particular server 42a-42n and pathname by which a file can be accessed, and then transmitted from server 42a-42n to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Design Facilitation and Manufacturer Procurement Overview

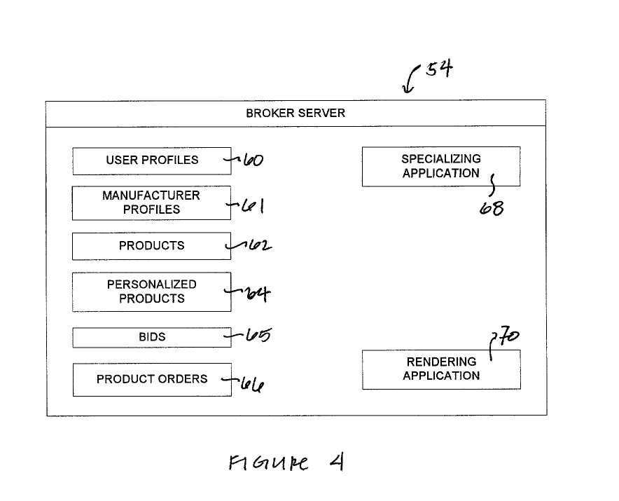

Referring now to FIG. 3, there is depicted a block diagram of a preferred client/server environment for facilitating a personalized design and then procuring local and remote manufacturers for the personalized design according to the method, system and program of the present invention. As illustrated, a client system 50 is connected to network 44. Client system 50 represents one of multiple client systems from which buyers may request access to a broker server 54 via network 44. Broker server 54 represents at least one server system which facilitates personalized designs via client system 50 and then communicates with multiple remote manufacturer systems 56a-56n and multiple local manufacturer systems 52a-52n via network 44. In addition, remote manufacturer systems 56a-56n and local manufacturer systems 52a-52n may further communicate with each other via network 44 in order to coordinate manufacturing. In an alternate embodiment, broker server 54 may be incorporated into client system 50, local manufacturer systems 52a-52n or remote manufacturer systems 56a-56n.

A user preferably utilizes client system 50 to request access to broker server 54. Broker server 54 then interacts with client system 50 to facilitate the user in personalizing a design. Broker server 54 preferably registers multiple local manufacturer systems 52a-52n and remote manufacturer systems 56a-56n according to categories of products available from each of the local and remote manufacturers. Broker server 54 may then facilitate personalized designs within the constraints of products offered by local and remote manufacturers.

In one embodiment of the present invention, the personalized design is for a product where local assembly is advantageous, however may require parts to be manufactured by remote manufacturers and provided to the local manufacturer for assembly. For example, a wedding cake may be a personalized design facilitated by broker server 54. Portions of the wedding cake design such as figurines or special sized cake pans to bake the cakes need to be provided by a remote manufacturer to a local baker who then bakes and assembles the wedding cake. In another example, it is preferable to utilize a local jeweler to assemble a ring, however the personalized design facilitated by broker server 54 may require a remote manufacturer to produce the band for the ring or cut the stone for the ring.

Users may advantageously provide customized specifications to broker server 54 via client system 50 or other media transmission method. Broker server 54 may then facilitate personalized designs offering the customized specifications provided by the user and further facilitate obtaining a manufacturer for the customized specifications. In particular, broker server 54 may first solicit bids for the personalized design from local manufacturers. Then, depending on manufacturable parts needed by the local manufacturers placing bids, broker server 54 may solicit bids from remote manufacturers.

With reference now to FIG. 4, there is depicted a block diagram of one embodiment of a broker server system in accordance with the method, system and program of the present invention. As illustrated, broker server 54 includes multiple databases including, but not limited to user profiles 60, manufacturer profiles 61, products 62, personalized products 64, bids 65 and product orders 66. In addition, broker server 54 may include multiple software applications such as specializing application 68 and rendering application 70.

Advantageously, user profiles 60 and manufacturer profiles 61 include, but are not limited to, registration information for users, local manufacturers, and remote manufacturers. User profiles 60 preferably includes, but is not limited to, a user identification, financial information, shipping information, personal information, design history, purchase history, ratings by local and remote manufacturers and customized specifications according to user. Manufacturer profiles 61 preferably includes, but are not limited to, a manufacturer identification, payment requirements, shipping information, delivery information, manufacturing history and ratings by users and other manufacturers.

Products 62 preferably includes, but is not limited to, a database of current product offerings as compiled from available local and remote manufacturers. Product offerings are preferably referenced by a product identification and the database further references attributes and variables available for each product offering, as will be further described.

Personalized products 64 preferably includes a database of selections by user when personalizing a product. A user may enter a product name to be associated with the personalized design and then order the personalized design or save the personalized design for future changes or ordering. Broker server 64 may utilize the information in personalized products 64 to monitor user preferences and other qualifiable information.

As a user is selecting a product, attributes and variables, rendering application 70 preferably renders a graphical representation of the personalized design that is then made available to the user. The rendered graphical representation is also transmitted to local and remote manufacturers with bid requests in order to show the product expected by the user. In particular, the graphical rendering may be stored at a particular location within broker server 54.

Once a user places an order, specializing application 68 preferably divides a personalized design into multiple manufacturable parts, submits bid requests to multiple local manufacturers and monitors the status of the order in product orders database 66. Local manufacturers in return provide bids on the personalized design which are stored in bids database 65. Bids by local manufacturers also indicate which of the multiple manufacturable parts the local manufacturer will need in order to manufacture and/or assemble the personalized design. In addition, the local manufacturer may indicate additional manufacturable parts or supplies which will be required to manufacture and/or assemble the personalized design.

Specializing application 64 preferably distributes additional bid requests to remote manufacturers for the manufacturable parts and any additional supplies required by local manufacturers who place bids. Bids that are received from the remote manufacturers are also stored in bids database 65. Specializing application 68 then provides a list of available manufacturers to the user for selection.

The selection of available manufacturers made by the user is further stored in product orders 66 and order requests are sent for the manufacturable parts to the selection of available manufacturers. In addition, specializing application 68 facilitates financial settlement between the user and the selected manufacturers.

Referring now to FIGS. 5A-5B, there is depicted a high level logic flowchart of the process and program for facilitating and brokering personalized designs according to the method, system and program of the present invention. As illustrated, the process starts at block 120 and thereafter proceeds to block 122. Block 122 depicts the determination of what event occurred when an event occurs. If a design request is received, then the process passes to block 124. If an order request is received, then the process passes to block 156.

In response to receiving a design request, block 124 depicts transmitting a selection of available products including the customized products according to user. As previously described, a user may provide customized product specifications that are formatted by the broker server for selection by the user during the personalized design process.

Next, block 126 illustrates a determination as to whether or not a selection by the user from among the products is received. If a product selection is not received, then the process passes to block 146. If a product selection is received, then the process passes to block 128.

Block 128 depicts rendering a generic graphical representation of the personalized design according to the product selection. Next, block 130 illustrates calculating an estimate for the personalized design according to the current selections and the process passes to block 132. The estimate may include cost, manufacturing time, delivery time, structural feasibility and other analysis as the user makes selections. The estimate may be provided to the user during the design process, at the conclusion of the design process, or hidden from the user. In addition, the estimate may be transmitted to the manufacturers with bid requests to provide a range of estimates preferred by the user and/or anticipated by the broker server. In addition, although not depicted, during the design process a user may select to receive advice or help, or alternatively advice or help may automatically be provided to aid the user in making selections.

Block 132 illustrates transmitting available attributes according to the product selection and customized attributes according to the user and the process passes to block 134. A user may provide customized attribute specifications that are formatted by the broker server and provided to the user during the design process.

Block 134 depicts a determination as to whether or not a selection from among the available attributes is received. If an attribute selection is not received, then the process passes to block 146. If an attribute selection is received, then the process passes to block 136.

Block 136 illustrates transmitting the available variables according to attribute selection and customized variables according to user and the process passes to block 138. A user may provide customized variable specifications that are formatted by the broker server and provided to the user during the design process. For example, a user may provide a photograph as a variable to be selected from among multiple graphical image variables.

Block 138 depicts a determination as to whether or not a selection by the user from among the variables is received. If a selection is not received, then the process passes to block 134. Otherwise, if a selection is received, then the process passes to block 140. Block 140 illustrates calculating an estimate, as previously described. Next, block 142 depicts rendering a representation of the personalized design according to the current selections and the process passes to block 138.

When no further selections have been made by the user, block 146 illustrates a determination as to whether the user indicates the design is completed. If the user does not indicate the design is completed, then the process passes to block 126. If the user indicates the design is completed, then the process passes to block 148.

Block 148 depicts storing the selections for the user according to a product name or other identification as provided by the user or assigned by the broker server. Next, block 150 illustrates analyzing the design integrity. In analyzing the integrity of a personalized design, multiple integrity qualifications may be analyzed including, but not limited to, chemical integrity, structural integrity, electrical integrity, and financial integrity. Thereafter, block 152 depicts a determination as to whether or not the design has integrity. If the design integrity is not questionable, then the process ends. If the design integrity is questionable, then the process passes to block 154. Block 154 illustrates suggesting adjustments to the current design and the process ends.

In response to receiving an order request, block 156 depicts apportioning a design order request into multiple manufacturable parts according to type of manufacture or other suitable criteria. Next, block 158 illustrates distributing the apportioned design order request to pertinent local manufacturers. Preferably a deadline is provided for returning bids on the design request. Thereafter, block 160 depicts a determination as to whether or not bids are received. If bids from local manufacturers are not received the process iterates at block 160 for a particular period of time. If bids from local manufacturers are received, then the process passes to block 162.

Block 162 depicts determining which parts are needed from remote manufacturers. In particular, local manufacturers will return bids based on the parts to be assembled and manufactured by the local manufacturer and indicate parts to be manufactured by remote manufacturers. Next, block 164 illustrates distributing bid requests for the needed parts to multiple remote manufacturers according to type of manufacture or other criteria. In addition, the needed parts bid requests may be sent to other local manufacturers who are able to manufacture needed parts. Preferably, a deadline for submitting bids is set with the needed parts bid requests. Thereafter, block 166 depicts a determination as to whether or not bids are received from the remote manufacturers. If bids have not been received, then the process iterates at block 160 for a particular period of time. If bids have been received, then the process passes to block 168.

Block 168 illustrates compiling the local and remote bids. In compiling the bids, multiple cost and delivery options are determined. Next, block 170 depicts presenting the cost and delivery options to the user based on the compiled local and remote bids. Preferably a deadline for selecting manufacturers is provided with the cost and delivery options. Thereafter, block 172 illustrates a determination as to whether or not the user has selected manufacturers from among the bids. If a user has not selected manufacturers from among the bids, then the process iterates at block 172 for a particular amount of time. If a user has selected from among the bids, then the process passes to block 174. Alternatively, the local manufacturer may first be given an opportunity to select from the bids by remote manufacturers such that the user is shown bids from local manufacturers with the cost and delivery adjustments already made according to remote manufacturer selection.

Block 174 depicts settling a financial transaction with the user for the design order. Next, block 176 illustrates placing an order for the design with the selected manufacturers and completing the financial transaction with those manufacturers and the process ends.

User Design Personalizing Context

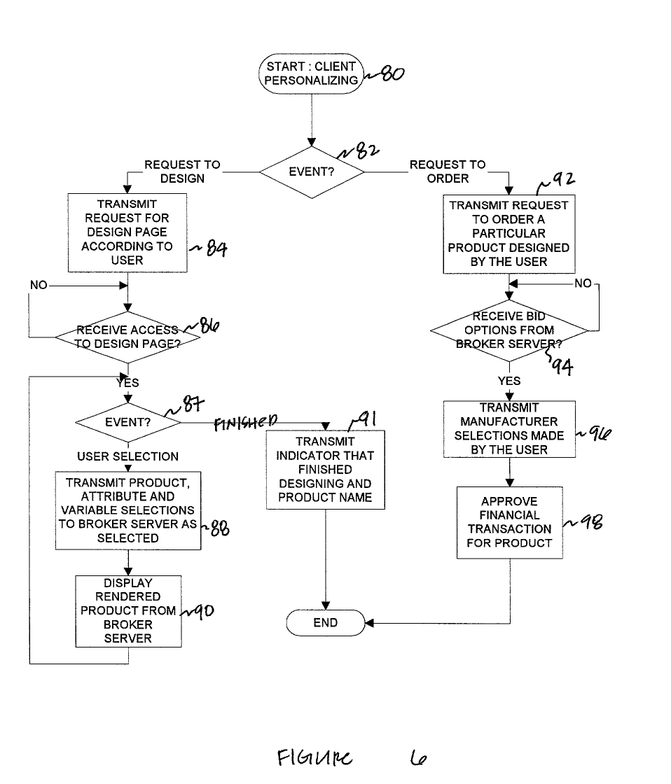

With reference now to FIG. 6, there is illustrated a high level logic flowchart of a process and program for personalizing a design and placing an order for that personalized design according to the method, system and program of the present invention. As depicted, the process starts at block 80 and thereafter proceeds to block 82. Block 82 illustrates a determination as to what type of event occurred when an event occurs. If a request to design is received, then the process passes to block 84. Alternatively, if a request to order is received, then the process passes to block 92.

Block 84 depicts transmitting a request for a design page from a broker server according to the user identification. Next, block 86 illustrates a determination as to whether or not access to a design page is received. If access is not received, then the process iterates at block 86 and may also exit the process if an error is detected. If access is received, then the process passes to block 87.

Block 87 illustrates a determination as to what event occurred when an event occurs. If the user makes a selection, then the process passes to block 88. If the user is finished making selections, then the process passes to block 91.

Block 88 depicts transmitting the product, attribute, or variable selections to the broker server as selected. Next, block 90 illustrates displaying the rendered graphical product representation received from the broker server and the process passes to block 87.

When the user is finished making selections, block 91 illustrates transmitting a request to save the selections according to a product name or other identifier and the process ends.

Upon receiving a user request to order a personalized design, block 92 depicts transmitting a personalized design order request according to a product name or other identifier. Next, block 94 illustrates a determination as to whether or not cumulative bids are received from the broker server. If cumulative bids are not received from the broker server, then the process iterates at block 94 for a particular time period. If cumulative bids are received from the broker server, then the process passes to block 96. Block 96 depicts transmitting any selections of manufacturers made by the user from the bid options. Next, block 98 illustrates approving a financial transaction for payment for the personalized design and the process ends.

Local Manufacturer Context

Referring now to FIG. 7, there is illustrated a high level logic flowchart of a process and program for controlling a local manufacturer system in accordance with the present invention. As depicted, the process starts at block 180 and thereafter proceeds to block 182. Block 182 illustrates a determination as to what type of event occurred when an event occurs. If a list of remote manufacturers is received, then the process passes to block 183. If a local bid request is received, then the process passes to block 186. Otherwise, a product order is received, then the process passes to block 192.

Block 183 depicts filtering the list of remote manufacturers according to preferences. Preferences may include a list of preferred manufacturers, types of preferred manufacturers, preferred locations for remote manufacturers, preferred pricing and other criteria that may be utilized to narrow the list of remote manufacturers. Next, block 184 illustrates transmitting a selection from among the remote manufacturers to the broker server and the process ends.

Block 186 illustrates filtering the local bid request according to manufacturing abilities of the local manufacturer. Next, block 188 depicts compiling a bid offer including a cost, delivery estimate, and selection of manufacturable parts to be received from a remote manufacturer. Thereafter, block 190 illustrates transmitting the bid offer to the broker server and the process ends.

Block 192 depicts processing the product order and the process ends. Processing the product order may include financial settlement, setting production deadlines, ordering parts and other steps including in manufacturing a product order.

Data Storage Context

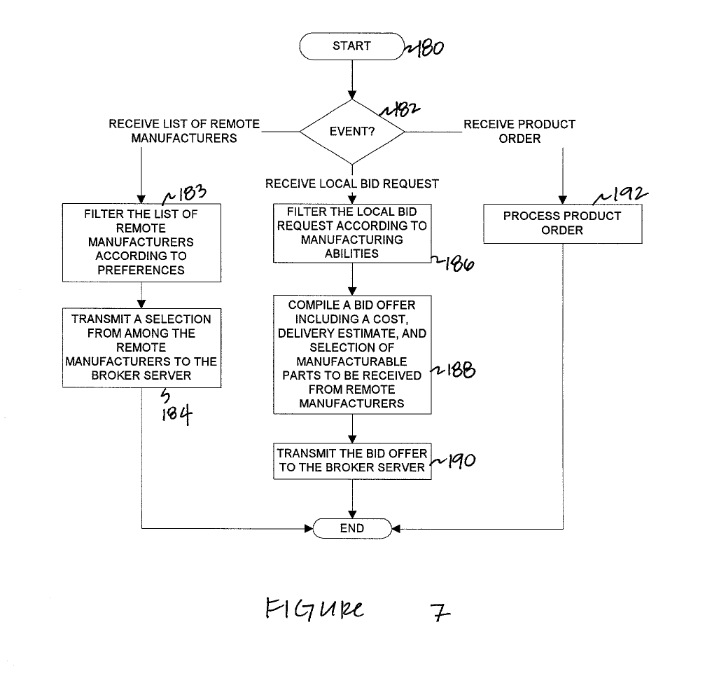

With reference now to FIG. 8, there is depicted a block diagram of a data storage structure for products in accordance with the method, system and program of the present invention. As illustrated, the data corresponding to available products is preferably stored in a data storage structure such as database table 200. The example database table 200 is provided in order to depict a selection of fields 202 which may be included in a data storage structure. Fields 202 include, but are not limited to, a product, attribute, variables, cost estimates and design advice. In alternate embodiments, alternate types of data storage structures and methods may be utilized.

In the example, the product “cake” has five attributes that may be personalized including, but not limited to, a number of cakes, figurines, flavors, cake shapes and cake sizes. Each attribute then has variables that may be selected from to further personalize a design. For example, a number of cakes in the range of one to thirty may be selected.

Advantageously, the product, attribute and variable selections are compiled from the products, attributes and variables provided by the registered manufacturers. Alternatively, a broker server may add product, attribute and variable selections as users indicate a preference for such.

Further, cost estimates and design advice may be provided as requested or as needed. In particular, design advice may include textual messages, graphical representations, demonstrations, wizard applications and other automated forms of aiding a user in personalizing a design. In addition, a user may directly contact a broker employee who aids the user is personalizing a design via a video display, textual display, voice output or other electronic communication tool.

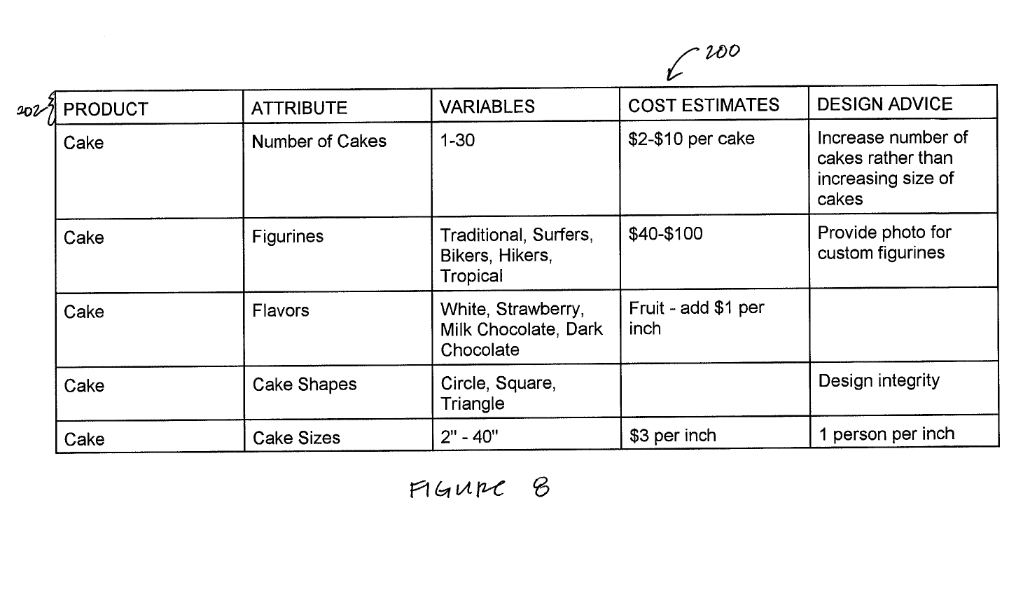

Referring now to FIG. 9, there is depicted a block diagram of a data storage structure for local manufacturer registration information in accordance with the method, system and program of the present invention. As illustrated, the data corresponding to local manufacturer registration information is preferably stored in a data storage structure such as database table 205. The example database table 205 is provided in order to depict a selection of fields 207 which may be included in a data storage structure. In alternate embodiments, alternate types of data storage structures and methods may be utilized.

Fields 207 include, but are not limited to, a local manufacturer identification (ID), products, scope of delivery, and contact information. In addition, although not depicted, a history of assembly and manufacture and ratings by users may also be stored according to local manufacturer ID.

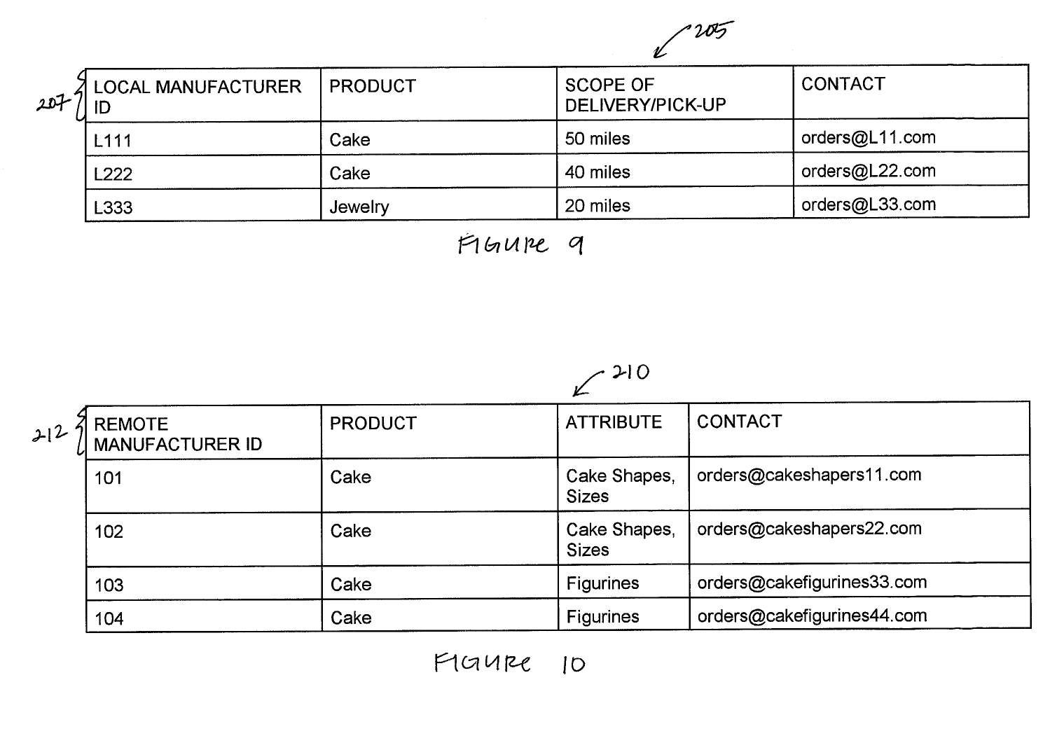

With reference now to FIG. 10, there is illustrated a block diagram of a data storage structure for remote manufacturer registration information in accordance with the method, system and program of the present invention. As illustrated, the data corresponding to remote manufacturer registration information is preferably stored in a data storage structure such as database table 210. The example database table 210 is provided in order to depict a selection of fields 212 which may be included in a data storage structure. In alternate embodiments, alternate types of data storage structures and methods may be utilized.

Fields 212 include, but are not limited to, a remote manufacturer ID, product, attribute and contact information. In addition, although not depicted, a history of manufacture, user ratings and other historical information may be stored according to manufacturer. In addition, although not depicted, manufacturers may be further categorized according to variables offered for each attribute.

Referring now to FIG. 11, there is depicted a block diagram of a data storage structure for user registration information in accordance with the method, system and program of the present invention. As illustrated, the data corresponding to user registration information is preferably stored in a data storage structure such as database table 220. The example database table 220 is provided in order to depict a selection of fields 222 which may be included in a data storage structure. In alternate embodiments, alternate types of data storage structures and method may be utilized.

Fields 222 include, but are not limited to, a user ID, personal information, financial information and shipping information. In addition, although not depicted, a history of personalized designs, purchases and ratings by manufacturers may be included.

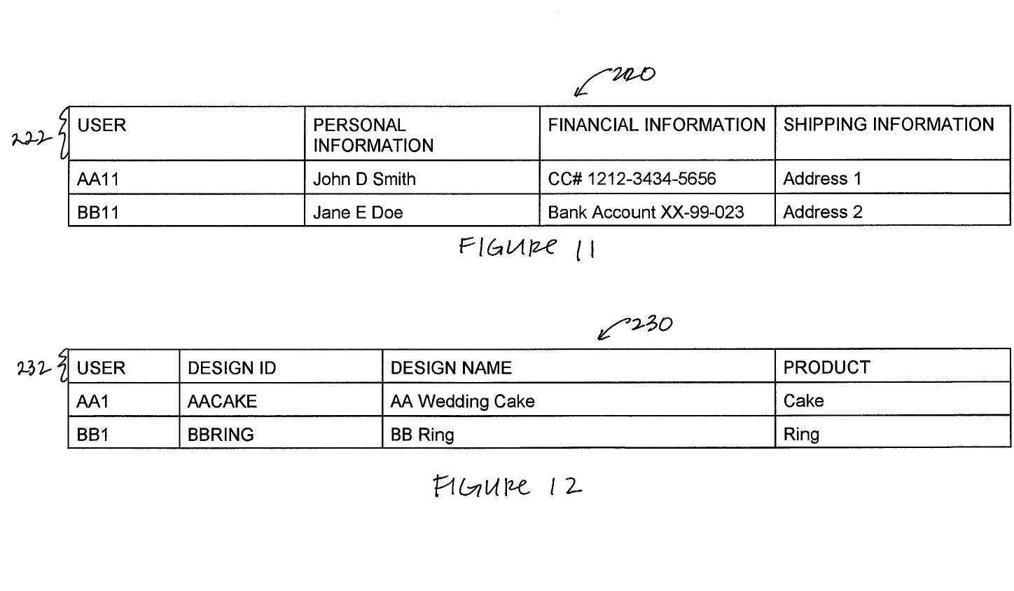

With reference now to FIG. 12, there is illustrated a block diagram of a data storage structure for tracking personalized designs in accordance with the method, system and program of the present invention. As depicted, the data corresponding to personalized design selections is preferably stored in a data storage structure such as database table 230. The example database table 230 is provided in order to depict a selection of fields 232 which may be included in a data storage structure. In alternate embodiments, alternate types of data storage structures and methods may be utilized.

Fields 232 include, but are not limited to, a user ID, a design ID, a design name and the product being personalized. Preferably, further selections for each design are then references by design ID, as will be further described. In addition, the design name may be provided by the user or may be designated by the broker server.

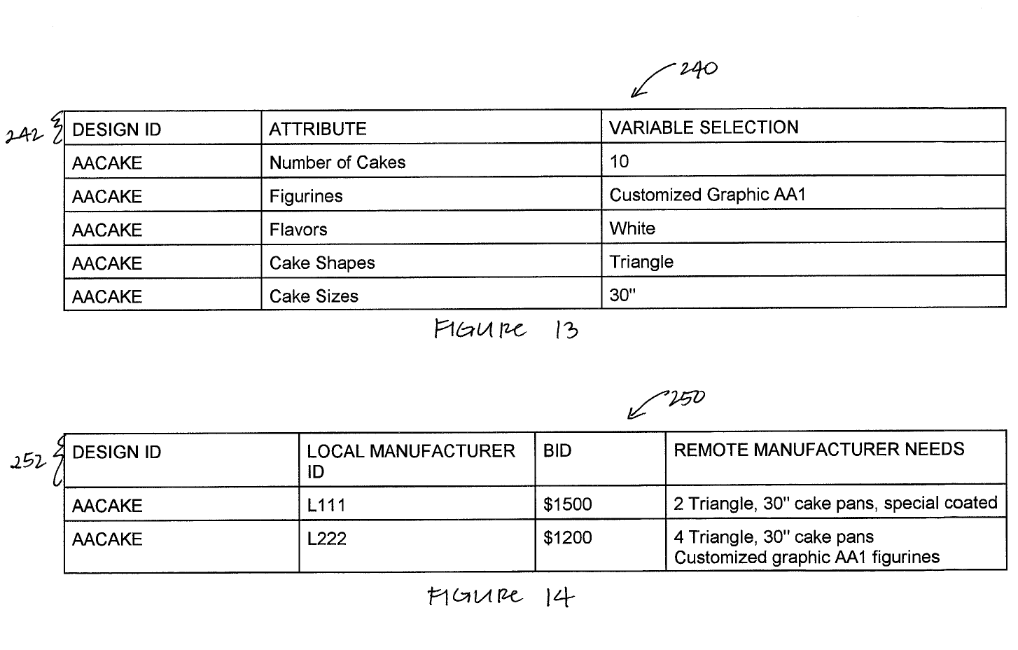

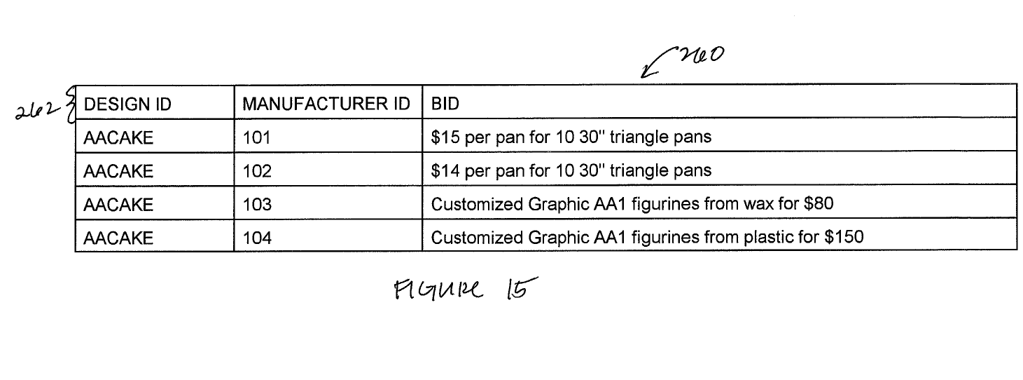

Referring now to FIG. 13, there is depicted a block diagram of a data storage structure for storing attribute and variable selections for a personalized design in accordance with the method, system and program of the present invention. As illustrated, the data corresponding to attribute and variable selections is preferably stored in a data storage structure such as database table 240. The example database table 240 is provided in order to depict a selection of fields 242 which may be included in a data storage structure. In alternate embodiments, alternate types of data storage structures and methods may be utilized.

Fields 242 include, but are not limited to, a design ID, an attribute, and a variable selection. As previously described in FIG. 11, a design ID references a user ID and product. Then, each attribute and variable selection is identified. In the present example, the variable selection for the figurine attribute is a “customizes graphic AA1” that is provided by the user for selection during design.

Preferably, the entries within database table 240 may further be utilized to determine the manufacturable parts of a design. For example, figurines may be one manufacturable part and cake pans that are a particular size and shape may be another manufacturable part.

With reference now to FIG. 15, there is illustrated a block diagram of a data storage structure for storing local manufacturer bids in accordance with the method, system and program of the present invention. As depicted, the data corresponding to local manufacturer bids is preferably stored in a data storage structure such as database table 250. The example database table 250 is provided in order to depict a selection of fields 252 which may be included in a data storage structure. In alternate embodiments, alternate types of data storage structures and methods may be utilized.

Fields 252 include, but are not limited to, a design ID, a local manufacturer ID, a bid for the personalized design and the selections needed from remote manufacturers. In particular, in indicating selections needed from remote manufacturers, a local manufacturer may provide additional specifications. For example, local manufacturer “L111” indicated that two triangle 30″ cake pans are needed and more specifically, special coated cake pans.

Referring now to FIG. 16, there is depicted a block diagram of a data storage structure for storing remote manufacturer bids in accordance with the method, system and program of the present invention. As illustrated, the data corresponding to remote manufacturer bids is preferably stored in a data storage structure such as database table 260. The example database table 260 is provided in order to depict a selection of fields 262 which may be included in a data storage structure. In alternate embodiments, alternate types of data storage structures and methods may be utilized.

Fields 262 include, but are not limited to, a design ID, a remote manufacturer ID and a bid for a manufacturable part. The broker server preferably utilizes both the local and remote manufacturer bids in compiling ordering options for a user and/or a local manufacturer.

While the invention has been particularly shown and described with reference to a preferred embodiment, it will be understood by those skilled in the art that various changes in form and detail may be made therein without departing from the spirit and scope of the invention.

What is claimed is:

1. A method for coordinating a plurality of local and remote manufacturers for a manufacturing order, said method comprising the steps of:
dividing a manufacturing order for a user into a plurality of manufacturable parts; and
submitting a local bid request for said manufacturing order to a plurality of local manufacturers; and
in response to receiving a plurality of local bids for said manufacturing order, submitting a remote bid request to a plurality of remote manufacturers for a selection of said plurality of manufacturable parts as requested in said plurality of local bids.

2. The method for coordinating a plurality of local and remote manufacturers according to claim 1, said method further comprising the step of:
submitting said local bid request and said remote bid request from a broker server communicatively connected through a network to a plurality of manufacturer systems.

3. The method for coordinating a plurality of local and remote manufacturers according to claim 1, said method further comprising the steps of:
facilitating said user in designing a personalized product; and
in response to receiving a request to order said personalized product, adjusting said personalized product into said manufacturing order.

4. The method for coordinating a plurality of local and remote manufacturers according to claim 3, said method further comprising the steps of:
in response to receiving a design request from a user, transmitting a plurality of available products to said user;
in response to receiving a product selection from among said plurality of available products, transmitting a plurality of available attributes to said user;
in response to receiving an attribute selection from among said plurality of available attributes, transmitting a plurality of available variables to said user; and
in response to a receiving a variable selection from among said plurality of available variables, rendering a graphical representation of said personalized product according to said product selection, said attribute selection and said variable selection.

5. The method for coordinating a plurality of local and remote manufacturers according to claim 4, said method further comprising the step of:
calculating a cost estimate for said personalized product according to said product selection, said attribute selection and said variable selection.

6. The method for coordinating a plurality of local and remote manufacturers according to claim 3, said method further comprising the steps of:
analyzing said personalized design for integrity; and
in response to finding integrity flaws in said personalized design, providing said user with suggestions for adjusting said personalized design.

7. The method for coordinating a plurality of local and remote manufacturers according to claim 1, said method further comprising the step of:
compiling said plurality of local bids and said plurality of remote bids into a plurality of selectable bid options for said user.

8. The method for coordinating a plurality of local and remote manufacturers according to claim 1, said method further comprising the steps of:
receiving a selection from said user from among said plurality of local bids and said plurality of remote bids;
transferring an order request for said manufacturing order according to said selection from among said plurality of local bids and said plurality of remote bids.

9. The method for coordinating a plurality of local and remote manufacturers according to claim 8, said method further comprising the step of:
completing a financial settlement from said user for said order request.

10. A system for coordinating a plurality of local and remote manufacturers for a manufacturing order, said system comprising:
a server system communicatively connected via a network to a plurality of local manufacturers and a plurality of remote manufacturers;
said server system comprising:
means for dividing a manufacturing order received at said server system from a user into a plurality of manufacturable parts; and
means for submitting a local bid request from said server system for said manufacturing order to said plurality of local manufacturers; and
means for submitting a remote bid request from said server system to a plurality of remote manufacturers for a selection of said plurality of manufacturable parts as requested in said plurality of local bids, in response to receiving a plurality of local bids for said manufacturing order at said server system.

11. The system for coordinating a plurality of local and remote manufacturers according to claim 10, said system further comprising:
means for facilitating said user in designing a personalized product; and
means for adjusting said personalized product into said manufacturing order, in response to receiving a request to order said personalized product.

12. The system for coordinating a plurality of local and remote manufacturers according to claim 11, said system further comprising:
means for transmitting a plurality of available products to said user from said server system, in response to receiving a design request from a user;
means for transmitting a plurality of available attributes to said user from said server system, in response to receiving a product selection from among said plurality of available products;
means for transmitting a plurality of available variables to said user from said server system, in response to receiving an attribute selection from among said plurality of available attributes; and
means for rendering a graphical representation of said personalized product according to said product selection from said server system, said attribute selection and said variable selection, in response to a receiving a variable selection from among said plurality of available variables.

13. The system for coordinating a plurality of local and remote manufacturers according to claim 12, said system further comprising:
means for calculating a cost estimate for said personalized product according to said product selection, said attribute selection and said variable selection.

14. The system for coordinating a plurality of local and remote manufacturers according to claim 11, said system further comprising:
means for analyzing said personalized design for integrity; and
means for providing said user with suggestions for adjusting said personalized design, in response to finding integrity flaws in said personalized design.

15. The system for coordinating a plurality of local and remote manufacturers according to claim 10, said system further comprising:
means for compiling said plurality of local bids and said plurality of remote bids into a plurality of selectable bid options for said user.

16. The system for coordinating a plurality of local and remote manufacturers according to claim 10, said system further comprising:
means for receiving a selection from said user from among said plurality of local bids and said plurality of remote bids at said server system;
means for transferring an order request from said server system for said manufacturing order according to said selection from among said plurality of local bids and said plurality of remote bids.

17. The system for coordinating a plurality of local and remote manufacturers according to claim 16, said system further comprising:
means for completing a financial settlement from said user for said order request.

18. A program for coordinating a plurality of local and remote manufacturers for a manufacturing order, residing on a computer usable medium having computer readable program code means, said program comprising:
means for dividing a manufacturing order for a user into a plurality of manufacturable parts; and
means for transmitting a local bid request for said manufacturing order to a plurality of local manufacturers; and
means for transmitting a remote bid request to a plurality of remote manufacturers for a selection of said plurality of manufacturable parts as requested in said plurality of local bids, in response to receiving a plurality of local bids for said manufacturing order.

19. The program for coordinating a plurality of local and remote manufacturers according to claim 18, said program further comprising:
means for facilitating said user in designing a personalized product; and
means for transferring said personalized product into said manufacturing order, in response to receiving a request to order said personalized product.

20. The program for coordinating a plurality of local and remote manufacturers according to claim 19, said program further comprising:
means for transmitting a plurality of available products to said user, in response to receiving a design request from a user;
means for transmitting a plurality of available attributes to said user, in response to receiving a product selection from among said plurality of available products;
means for transmitting a plurality of available variables to said user, in response to receiving an attribute selection from among said plurality of available attributes; and
means for generating a graphical representation of said personalized product according to said product selection, said attribute selection and said variable selection, in response to a receiving a variable selection from among said plurality of available variables.

21. The program for coordinating a plurality of local and remote manufacturers according to claim 20, said program further comprising:
means for calculating a cost estimate for said personalized product according to said product selection, said attribute selection and said variable selection.

22. The program for coordinating a plurality of local and remote manufacturers according to claim 19, said program further comprising:
means for analyzing said personalized design for integrity; and
means for notifying said user with suggestions for adjusting said personalized design, in response to finding integrity flaws in said personalized design.

23. The program for coordinating a plurality of local and remote manufacturers according to claim 18, said program further comprising:
means for compiling said plurality of local bids and said plurality of remote bids into a plurality of selectable bid options for said user.

24. The program for coordinating a plurality of local and remote manufacturers according to claim 18, said program further comprising:
means for receiving a selection from said user from among said plurality of local bids and said plurality of remote bids;
means for transmitting an order request for said manufacturing order according to said selection from among said plurality of local bids and said plurality of remote bids.

25. The program for coordinating a plurality of local and remote manufacturers according to claim 24, said program further comprising:
means for completing a financial settlement from said user for said order request.

26. A method for customizing bids for a personalized product, said method comprising the steps of:
receiving a bid request for a personalized product at a local manufacturer, wherein said bid request comprises a plurality of manufacturable parts; and
returning a bid offer for said personalized product specifying a selection of said plurality of manufacturable parts to be provided by a remote manufacturer, such that said local manufacturer customizes said bid offer for said personalized product.

27. The method for customizing bids for a personalized product according to claim 26, said step of receiving a bid request for a personalized product further comprising the step of:
receiving said bid request at a local manufacturer system communicatively connected to a network with a broker server comprising means for receiving requests from users.

28. The method for customizing bids for a personalized product according to claim 26, said step of returning a bid offer further comprising the step of:
requiring an option to select from among a plurality of bids for said selection of said plurality of manufacturable parts from a plurality of remote manufacturers.

29. A system for customizing bids for a personalized product, said system comprising:
a manufacturer server system communicatively connected via a network to a broker server system enabled to receive a bid request from a user;
said manufacturer server system comprising:
means for receiving said bid request for a personalized product at a local manufacturer, wherein said bid request comprises a plurality of manufacturable parts; and
means for returning a bid offer for said personalized product specifying a selection of said plurality of manufacturable parts to be provided by a remote manufacturer, such that said local manufacturer customizes said bid offer for said personalized product.

30. The system for customizing bids for a personalized product according to claim 29, said means for receiving a bid request for a personalized product further comprising:
means for receiving said bid request at a local manufacturer system communicatively connected to a network with said broker server system.

31. The system for customizing bids for a personalized product according to claim 29, said means for returning a bid offer further comprising:
means for requiring an option to select from among a plurality of bids for said selection of said plurality of manufacturable parts from a plurality of remote manufacturers.

32. A program for customizing bids for a personalized product, residing on a computer usable medium having computer readable program code means, said program comprising:
means for receiving a bid request for a personalized product at a local manufacturer, wherein said bid request comprises a plurality of manufacturable parts; and
means for returning a bid offer for said personalized product specifying a selection of said plurality of manufacturable parts to be provided by a remote manufacturer, such that said local manufacturer customizes said bid offer for said personalized product.

33. The program for customizing bids for a personalized product according to claim 32, said program further comprising:
means for receiving said bid request at a local manufacturer system communicatively connected to a network with a broker server.

34. The program for customizing bids for a personalized product according to claim 32, said program further comprising:
means for requiring an option to select from among a plurality of bids for said selection of said plurality of manufacturable parts from a plurality of remote manufacturers.

35. A method for procuring manufacturers, said method comprising the steps of:
facilitating a user entry of a personalized design; and
procuring at least one remote manufacturer for manufacturing a particular portion of a personalized design order, such that a local manufacturer is enabled to manufacture and assemble said personalized design utilizing said particular portion manufactured by said at least one remote manufacturer.
